(19) United States
(12) Patent Application Publication
(10) Pub. No.: US 2025/0080709 A1
(43) Pub. Date: Mar. 6, 2025

(54) MEASUREMENT SYSTEM, INFORMATION PROCESSING APPARATUS, MEASUREMENT METHOD, AND PROGRAM

(71) Applicant: SONY GROUP CORPORATION, TOKYO (JP)

(72) Inventors: YUJI NAKAHATA, TOKYO (JP); SATOSHI MITANI, TOKYO (JP)

(21) Appl. No.: 18/727,274

(22) PCT Filed: Jan. 6, 2022
(86) PCT No.: PCT/JP2022/046127

§ 371 Date: Jul. 8, 2024

(30) Foreign Application Priority Data
Jan. 18, 2022 (JP) 2022-005710

(51) Int. Cl. H04N 13/125; H04N 13/302; H04N 13/383; H04N 17/04

(52) U.S. Cl. CPC H04N 13/125; H04N 13/302; H04N 13/383; H04N 17/04

(57) ABSTRACT

To provide a measurement system, an information processing apparatus, a measurement method, and a program by which a high-quality viewing experience can be realized. In order to accomplish the above-mentioned objective, a measurement system according to an embodiment of the present technology includes a luminance meter, an image display apparatus that tracks an object associated with the luminance meter and emits a right-eye image or a left-eye image, a movement apparatus that moves the luminance meter, and an information processing apparatus including a movement control unit, a first acquisition unit, an exposure control unit, and a second acquisition unit. The movement control unit controls the movement apparatus in accordance with a measurement point. The first acquisition unit acquires movement information regarding a movement time of a luminance meter, the movement information including at least position information of the luminance meter. The exposure control unit controls an exposure timing of the luminance meter on the basis of the movement information. The second acquisition unit acquires, in a case where a sum of the respective amounts of exposure acquired at the at least one exposure timing has satisfied a predetermined condition, the sum of the respective amounts of exposure as luminance data.

### TECHNICAL FIELD

The present technology relates to a measurement system, an information processing apparatus, a measurement method, and a program that can be applied to evaluation of crosstalk.

### BACKGROUND ART

Patent Literature 1 describes a photometric apparatus that receives light from a measurement target object and calculates a colorimetric value on the basis of the amount of light acquired. In this photometric apparatus, the colorimetric value is calculated by multiplying a reference colorimetric value based on reference colorimetric value data at a first predetermined time by a ratio of a small maxima to a large maxima in waveform data at a second predetermined time. Accordingly, correct measurement of a crosstalk value is achieved (specification paragraphs to [0046], [0055] to [0060], FIG. 4, etc. in Patent Literature 1).

### CITATION LIST

### Patent Literature

Patent Literature 1: Japanese Patent Application Laid-open No. 2012-247285

### DISCLOSURE OF INVENTION

### Technical Problem

In such a display apparatus capable of viewing a stereoscopic image, it is desirable to provide a technology capable of realizing a high-quality viewing experience.

In view of the above-mentioned circumstances, it is an objective of the present technology to provide a measurement system, an information processing apparatus, a measurement method, and a program by which a high-accuracy crosstalk measurement can be realized.

### Solution to Problem

In order to accomplish the above-mentioned objective, a measurement system according to an embodiment of the present technology includes a luminance meter, an object, an image display apparatus, a movement apparatus, and an information processing apparatus.

The object is associated with the luminance meter.

The image display apparatus includes a sensor unit that tracks the object and emits a right-eye image or a left-eye image to the luminance meter.

The movement apparatus moves the luminance meter.

The information processing apparatus includes a movement control unit, a first acquisition unit, an exposure control unit, and a second acquisition unit. The movement control unit controls the movement apparatus in accordance with a measurement point based on the image display apparatus.

The first acquisition unit acquires movement information regarding a movement time of a luminance meter, the movement information including at least position information of the luminance meter.

The exposure control unit controls an exposure timing of the luminance meter on the basis of the movement information.

The second acquisition unit acquires, in a case where a sum of the respective amounts of exposure acquired at the at least one exposure timing has satisfied a predetermined condition, the sum of the respective amounts of exposure as luminance data.

In this measurement system, the exposure timing of the luminance meter is controlled on the basis of the movement information regarding the movement time of the luminance meter. In a case where the sum of the respective amounts of exposure acquired at the at least one exposure timing has satisfied the predetermined condition, the sum of the respective amounts of exposure is acquired as the luminance data. Accordingly, a high-quality viewing experience can be realized.

The information processing apparatus may include an evaluation unit that evaluates crosstalk of the image display apparatus on the basis of the luminance data.

The movement information may include a velocity of the luminance meter. In this case, the exposure control unit may start exposure of the luminance meter in a case where the luminance meter has reached a predetermined position and a predetermined velocity.

The movement information may include a movement time of the luminance meter. In this case, the exposure control unit may stop exposure of the luminance meter in a case where the movement time is other than a predetermined time zone.

The information processing apparatus may include a setting unit that sets the measurement point. In this case, the setting unit may set a predetermined position at which the crosstalk of the image display apparatus is assumed to occur or a region including the predetermined position as the measurement point.

The movement control unit may control the movement apparatus so that the luminance meter moves in accordance with a shape of the region.

The setting unit may set a region having a shape extending in a predetermined direction as the measurement point. In this case, the movement control unit may control the movement apparatus so that the luminance meter moves in the predetermined direction.

The movement control unit may control the movement apparatus so that the luminance meter moves in a circular arc on the basis of the predetermined position.

The evaluation unit may evaluate the crosstalk on the basis of a luminance distribution of the measurement point measured in advance and the luminance data.

The measurement system may further include a mirror that reflects the right-eye image or the left-eye image toward the luminance meter.

The measurement system may further include a mirror-moving apparatus that rotates and moves the mirror. In this case, the movement control unit may control the mirror-moving apparatus to fix the luminance meter and cause the right-eye image or the left-eye image to enter the luminance meter.

The measurement system may further include a light source that emits light out of a visible range to the object. In this case, the light out of the visible range may be infrared light.

The evaluation unit may calculate a value of crosstalk on the basis of the luminance data in each region of the right-eye image or the left-eye image.

The information processing apparatus may include a display control unit that controls the right-eye image and the left-eye image emitted from the image display apparatus. In this case, the display control unit may control white images, black images, or particular images including a predetermined pattern to be emitted as the right-eye image and the left-eye image.

An information processing apparatus according to an embodiment of the present technology includes a first acquisition unit, an exposure control unit, and a second acquisition unit.

The first acquisition unit acquires movement information regarding a movement time of a luminance meter, the movement information including at least position information of the luminance meter.

The exposure control unit controls an exposure timing of the luminance meter on the basis of the movement information.

The second acquisition unit acquires, in a case where a sum of the respective amounts of exposure acquired at the at least one exposure timing has satisfied a predetermined condition, the sum of the respective amounts of exposure as luminance data.

The measurement system may further include an evaluation unit that evaluates crosstalk of the image display apparatus on the basis of the luminance data.

The information processing apparatus may further include a movement control unit that controls a movement apparatus in accordance with a measurement point based on the image display apparatus. In this case, the image display apparatus may include a sensor unit that tracks an object associated with the luminance meter.

A measurement method according to an embodiment of the present technology is a measurement method executed by a computer system and includes controlling the movement apparatus in accordance with a measurement point based on an image display apparatus that includes a sensor unit that tracks an object associated with a luminance meter and emits a right-eye image or a left-eye image to the luminance meter.

Movement information regarding a movement time of a luminance meter is acquired, the movement information including at least position information of the luminance meter.

An exposure timing of the luminance meter is controlled on the basis of the movement information.

In a case where a sum of the respective amounts of exposure acquired at the at least one exposure timing has satisfied a predetermined condition, the sum of the respective amounts of exposure is acquired as luminance data.

A program according to an embodiment of the present technology causes a computer system to execute the following steps.

A step of controlling the movement apparatus in accordance with a measurement point based on an image display apparatus that includes a sensor unit that tracks an object associated with a luminance meter and emits a right-eye image or a left-eye image to the luminance meter.

A step of acquiring movement information regarding a movement time of a luminance meter, the movement information including at least position information of the luminance meter.

A step of controlling an exposure timing of the luminance meter on the basis of the movement information.

A step of acquiring, in a case where a sum of the respective amounts of exposure acquired at the at least one exposure timing has satisfied a predetermined condition, the sum of the respective amounts of exposure as luminance data.

### BRIEF DESCRIPTION OF DRAWINGS

FIG. 1 A view showing an overview of a measurement system.

FIG. 2 A block diagram showing a configuration example of an information processing apparatus.

FIG. 3 A flowchart showing measurement of luminance data.

FIG. 4 A view schematically showing another measurement example of a luminance meter.

FIG. 5 A view schematically showing another measurement example of the luminance meter.

FIG. 6 A schematic view showing another example of the measurement system.

FIG. 7 A block diagram showing a hardware configuration example of the information processing apparatus.

FIG. 8 A view schematically showing pattern images and crosstalk.

### MODE(S) FOR CARRYING OUT THE INVENTION

Hereinafter, embodiments according to the present technology will be described with reference to the drawings.

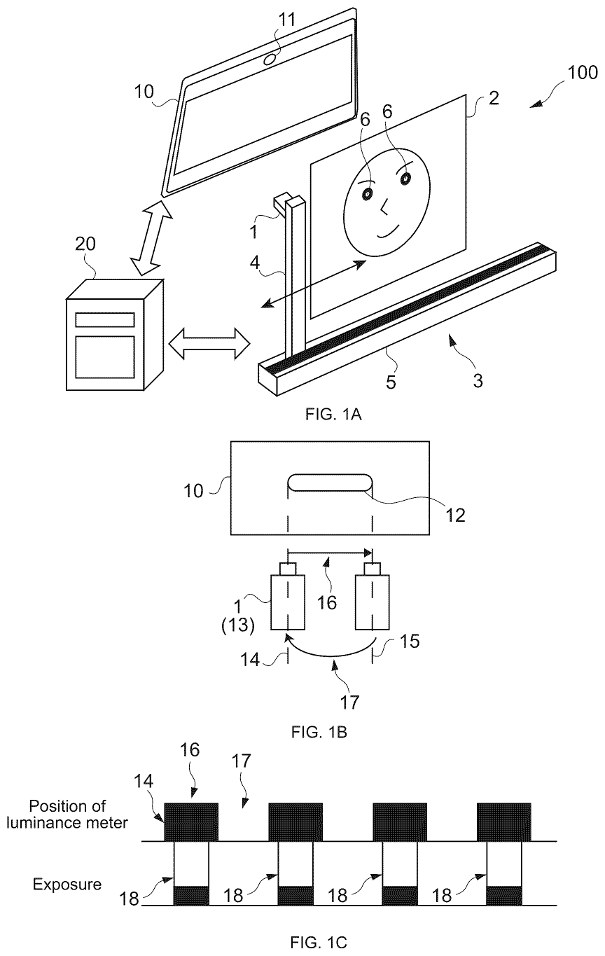

FIG. 1 is a view showing an overview of a measurement system 100 according to the present technology.

A of FIG. 1 is a view schematically showing the measurement system 100. As shown in A of FIG. 1, the measurement system 100 includes a luminance meter 1, an object 2, a movement apparatus 3, an auto-stereoscopic display (auto-stereoscopic image display apparatus) 10, and an information processing apparatus 20.

The luminance meter 1 detects a luminance of a right-eye image or a left-eye image emitted from the auto-stereoscopic display 10. In the present embodiment, the movement apparatus 3 supports the luminance meter 1 and the luminance meter 1 also moves along with a movement of the movement apparatus 3. For example, a two-dimensional luminance meter capable of acquiring data on a luminance and the like in a two-dimensional manner may be used as the luminance meter 1, and a luminance value in a desired area may be acquired.

The object 2 is arranged to be sensed by the auto-stereoscopic display 10. For example, in A of FIG. 1, the object 2 is a picture representing a human face. In the present embodiment, the right eye and the left eye have holes 6 and the luminance meter 1 is installed in these positions. That is, the luminance meter 1 moves together with the object 2 and detects the luminance of the right-eye image or the left-eye image emitted from the auto-stereoscopic display 10 through the hole 6 for the right eye or through the hole 6 for the left eye.

It should be noted that the object used for sensing is not limited, and any object may be used in accordance with a sensing method. For example, a marker may be associated with the object 2 and the marker may be tracked. In this case, a hole is opened at the marker position and the luminance meter 1 detects the luminance through the hole.

The movement apparatus 3 includes a support bar 4 that supports the luminance meter 1 and a driving stage 5 that drives the support bar 4. In the present embodiment, the movement apparatus 3 drives the driving stage 5, thereby moving the support bar 4. Accordingly, it is possible to move the luminance meter 1 to reach a predetermined position and a predetermined velocity.

It should be noted that the shape of the movement apparatus 3 is not limited, and the movement apparatus 3 may include the driving stage 5 capable of being driven in a circular arc on the basis of the auto-stereoscopic display 10 or the movement apparatus 3 may be capable of being driven in any direction such as a front-rear direction or an oblique direction with respect to the auto-stereoscopic display 10. As a matter of course, the support bar 4 may be provided with a joint portion capable of changing the position of the luminance meter 1.

The auto-stereoscopic display 10 is a display apparatus capable of displaying a stereoscopic image (right-eye image and left-eye image). The auto-stereoscopic display 10 is capable of displaying a stereoscopic three-dimensional video by emitting different parallax images between the right eye and the left eye at respective different viewpoints.

In the present embodiment, the auto-stereoscopic display 10 includes a camera 11. The camera 11 is capable of tracking the object 2. For example, in A of FIG. 1, the camera 11 tracks the right eye and the left eye in which the luminance meter 1 is installed. That is, on the basis of positions of the right eye and the left eye of the object 2 tracked, the auto-stereoscopic display 10 performs control so that the right-eye image enters the right eye and the left-eye image enters the left eye.

Moreover, in the present embodiment, the auto-stereoscopic display 10 emits white images, black images, or particular images including a predetermined pattern which are used checking crosstalk as the right-eye image and the left-eye image. Hereinafter, the white images, the black images, or the particular images including a predetermined pattern will be referred to as pattern images.

In the present embodiment, the particular images including a predetermined pattern are a right-eye image and a left-eye image different in luminance level. For example, in a case where the black image enters the right eye and the white image enters the left eye, the white image is mixed in the black image (or the black image is mixed in the white image) if crosstalk occurs. The crosstalk is evaluated based on a degree of such mixing.

It should be noted that the type of particular images including a predetermined pattern is not limited, and the right-eye image and the left-eye image different in a position of an object displayed in an image, a depth of the object, a shape of the object, or the like may be used.

The information processing apparatus 20 controls the movement apparatus 3 in accordance with a measurement point based on the auto-stereoscopic display 10. The measurement point is a position where crosstalk is assumed to occur. For example, for checking whether or not crosstalk occurs at a position in front of the auto-stereoscopic display 10, the position is a measurement point. Typically, the position where the crosstalk occurs depends on the design and the like of the auto-stereoscopic display 10.

In the present embodiment, a position (point) where crosstalk is assumed to occur or a region including the position is set as the measurement point.

B of FIG. 1 is a view schematically showing measurement of the luminance meter.

As shown in B of FIG. 1, a measurement point 12 is set to be a rectangular region whose end portions are rounded, which extends in a predetermined direction (e.g., a horizontal direction). In this case, the information processing apparatus 20 controls the movement apparatus (not shown) so that the luminance meter 1 moves in the predetermined direction. It should be noted that the shape of the measurement point is not limited and the shape of the measurement point may be rectangular or elliptical.

Moreover, the information processing apparatus 20 controls the exposure timing of the luminance meter 1 on the basis of movement information of the luminance meter 1 obtained from the movement apparatus 3. The movement information is information regarding a movement time of the luminance meter 1. For example, the movement information includes the position, the velocity, and the movement time of the luminance meter 1. In the present embodiment, when the luminance meter 1 reaches the predetermined position and the predetermined velocity, the information processing apparatus 20 outputs a trigger to start exposure to the luminance meter 1 (hereinafter, referred to as exposure ON trigger).

Moreover, the information processing apparatus 20 acquires luminance data in a case where the amount of exposure acquired by the luminance meter 1 has satisfied a predetermined condition, i.e., in a case where the amount of exposure has been sufficiently secured. In the present embodiment, the exposure duration is short with only one exposure performed while the luminance meter 1 is moving, so measurement is performed multiple times. That is, exposure is performed when the luminance meter 1 reaches the predetermined position and the predetermined velocity, and then exposure is performed when the luminance meter 1 returns to the original position (e.g., a position 13 of the luminance meter 1 in B of FIG. 1) and reaches the predetermined position and the predetermined velocity.

C of FIG. 1 is a view showing an acquisition sequence of the luminance data.

As shown in B and C of FIG. 1, the luminance meter 1 moves between a start point 14 and an end point 15 of the measurement point 12 and starts exposure by the exposure ON trigger. It should be noted that a movement of the luminance meter 1 from the start point 14 to the end point 15 will be referred to as a movement 16 and a movement of the luminance meter 1 to return from the end point 15 to the start point 14 will be referred to as a movement 17.

As shown in C of FIG. 1, the information processing apparatus 20 acquires movement information of the luminance meter 1 and outputs an exposure ON trigger 18 to the luminance meter 1 when the luminance meter 1 reaches the predetermined position and the predetermined velocity during the movement 16. The luminance meter 1 starts second exposure by performing the movement 16 again through the movement 17. In C of FIG. 1, the information processing apparatus 20 sends the exposure ON trigger 18 four times and acquires a sum of amounts of exposure for four times, which has been measured, as luminance data.

It should be noted that the exposure of the luminance meter 1 may be stopped by an exposure OFF trigger to stop exposure or may be set in advance to stop after several seconds elapse from the exposure ON trigger. It should be noted that although the start point 14 of the measurement point 12 is different from the position of the luminance meter 1 when the exposure ON trigger 18 is supplied in C of FIG. 1, the start point 14 of the measurement point 12 may be the same as the position of the luminance meter 1 when the exposure ON trigger 18 is supplied. That is, the start point 14 of the measurement point 12 may be set to a position when the luminance meter 1 reaches the predetermined position and the predetermined velocity. Moreover, the end point 15 of the measurement point 12 may be set to be a position to which the luminance meter 1 moves until the luminance meter 1 is stopped after the start of exposure.

Moreover, the information processing apparatus 20 evaluates crosstalk of the auto-stereoscopic display 10 on the basis of the luminance data acquired at at least one exposure timing. In the present embodiment, crosstalk while the luminance meter 1 is moving, i.e., dynamic crosstalk is converted into a numeric value on the basis of the luminance data.

It should be noted that the dynamic crosstalk refers to crosstalk generated for a time (motion to photon latency) for which the luminance meter 1 moves, the position of the luminance meter 1 is recognized, a stereoscopic image is drawn and generated and output to the display of the auto-stereoscopic display 10, and light is actually emitted.

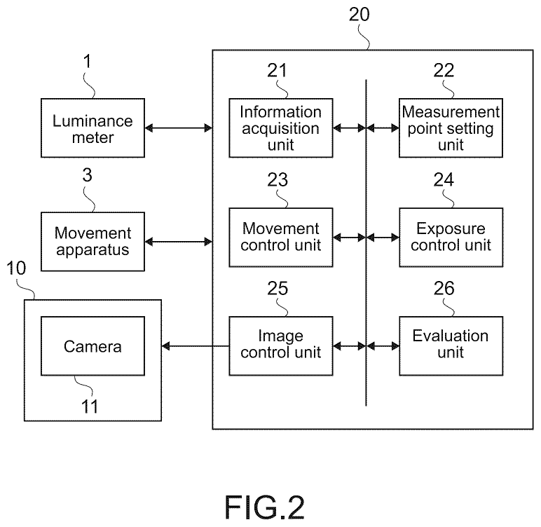

FIG. 2 is a block diagram showing a configuration example of the information processing apparatus 20 shown in FIG. 1.

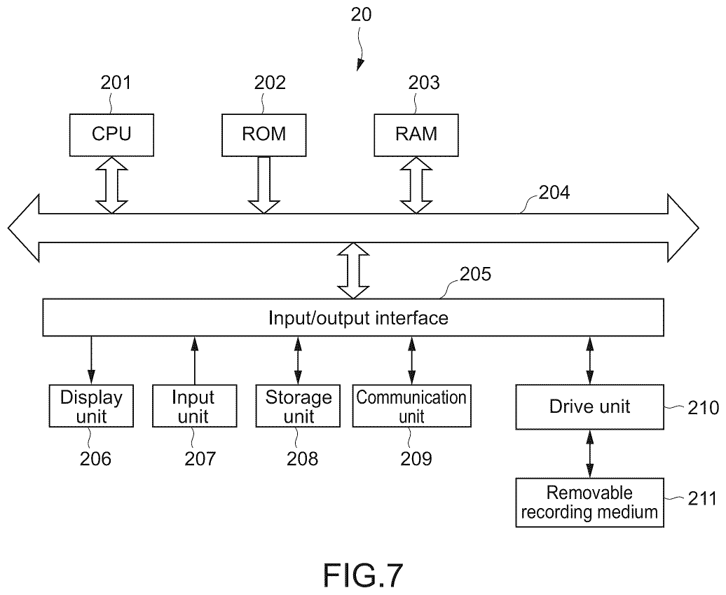

The information processing apparatus 20 includes hardware required for a computer configuration, such as processors, e.g., a CPU, a GPU, and a DSP, memories, e.g., a ROM and a RAM, and a storage device, e.g., an HDD (see FIG. 7). For example, by the CPU loading a program according to the present technology recorded on the ROM or the like in advance into the RAM and executing it, an information processing method according to the present technology is executed.

For example, any computer such as a PC can realize the information processing apparatus 20. As a matter of course, hardware such as an FPGA and an ASIC may be used.

In the present embodiment, an evaluation unit as a functional block is configured by the CPU executing a predetermined program. As a matter of course, dedicated hardware such as an integrated circuit (IC) may be used in order to realize the functional blocks.

The program is installed into the information processing apparatus 20, for example, via various recording media. Alternatively, the program may be installed via the Internet or the like.

The type of recording medium on which the program is recorded and the like are not limited, and any computer-readable recording medium may be used. For example, any computer-readable non-transitory storage medium may be used.

As shown in FIG. 2, the information processing apparatus 20 includes an information acquisition unit 21, a measurement point setting unit 22, a movement control unit 23, an exposure control unit 24, an image control unit 25, and an evaluation unit 26.

The information acquisition unit 21 acquires various types of information. In the present embodiment, the information acquisition unit 21 acquires the luminance data from the luminance meter 1 and acquires the movement information of the luminance meter 1 from the movement apparatus 3. Moreover, the acquired movement information is supplied to the exposure control unit 24. The luminance data is supplied to the evaluation unit 26.

The measurement point setting unit 22 sets a measurement point. In the present embodiment, the measurement point setting unit 22 sets a start point and an end point of the measurement point. For example, the measurement point setting unit 22 sets the positions of the start point and the end point in accordance with a direction in which the movement apparatus 3 is capable of being driven. It should be noted that in a case where the measurement point is not a region, but only a single point, the same position (coordinates) may be set as the start point and the end point. Information about the set measurement point is supplied to the movement control unit 23 and the image control unit 25.

The movement control unit 23 controls the movement apparatus 3. In the present embodiment, the movement control unit 23 controls the driving stage 5 of the movement apparatus 3 on the basis of the set measurement point. For example, the movement control unit 23 outputs to the movement apparatus 3 a control signal for controlling the driving stage 5 so that the luminance meter 1 reaches the predetermined position and the predetermined velocity between the start point and the end point.

The exposure control unit 24 controls the exposure timing of the luminance meter 1. In the present embodiment, the exposure control unit 24 outputs the exposure ON trigger to the luminance meter 1 on the basis of the movement information of the luminance meter 1 supplied from the movement apparatus 3.

The image control unit 25 controls an image displayed on the auto-stereoscopic display 10. In the present embodiment, the image control unit 25 controls so that the pattern images are displayed on the display of the auto-stereoscopic display 10.

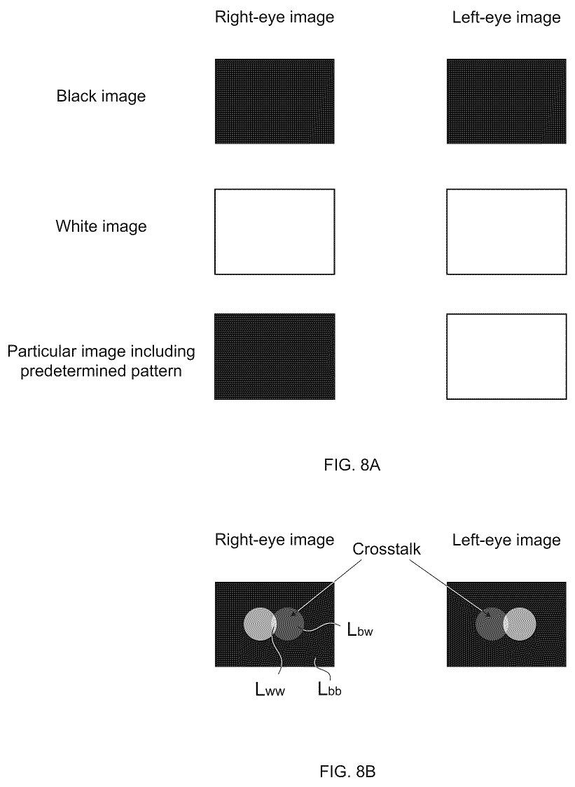

For example, as shown in A of FIG. 8, the image control unit 25 displays white images on the display in a case where detection of the luminance meter 1 when black images are displayed as the right-eye image and the left-eye image ends. Moreover, for example, in a case where detection of the luminance meter 1 when white images are displayed as the right-eye image and the left-eye image ends, the image control unit 25 displays a black image as the right-eye image and a white image as the left-eye image on the display as particular images.

The evaluation unit 26 evaluates crosstalk of the auto-stereoscopic display 10. In the present embodiment, the evaluation unit 26 calculates a value of crosstalk on the basis of the luminance data in each region of the right-eye image or the left-eye image.

For example, as shown in B of FIG. 8, a value X of crosstalk is calculated by using the following expression for luminance data of respective regions Lww, Lbw, and Lbb of the right-eye image or the left-eye image in a case where crosstalk occurs.

$$X = ( Lbw - Lbb ) / ( Lww - Lbb )$$

As a matter of course, the expression for determining crosstalk is not limited, and it may be calculated by any mathematical method. For example, in a case where an image other than the black image and the white image is used, any gradation of this image may be substituted into the expression and the value of crosstalk may be calculated.

It should be noted that in the present embodiment, the auto-stereoscopic display 10 corresponds to an image display apparatus that includes a sensor unit that tracks an object and emits the right-eye image or the left-eye image to the luminance meter.

It should be noted that in the present embodiment, the information acquisition unit 21 functions as a first acquisition unit that acquires movement information regarding a movement time of a luminance meter, the movement information including at least position information of the luminance meter, and a second acquisition unit that acquires, in a case where a sum of the respective amounts of exposure acquired at the at least one exposure timing has satisfied a predetermined condition, the sum of the respective amounts of exposure as luminance data.

It should be noted that in the present embodiment, the measurement point setting unit 22 corresponds to a setting unit that sets the measurement point.

It should be noted that in the present embodiment, the movement control unit 23 corresponds to a movement control unit that controls the movement apparatus in accordance with a measurement point based on the image display apparatus.

It should be noted that in the present embodiment, the exposure control unit 24 corresponds to an exposure control unit that controls an exposure timing of the luminance meter on the basis of the movement information.

It should be noted that in the present embodiment, the image control unit 25 corresponds to a display control unit that controls the right-eye image and the left-eye image emitted from the image display apparatus.

It should be noted that in the present embodiment, the evaluation unit 26 corresponds to an evaluation unit that evaluates crosstalk of the image display apparatus on the basis of the luminance data.

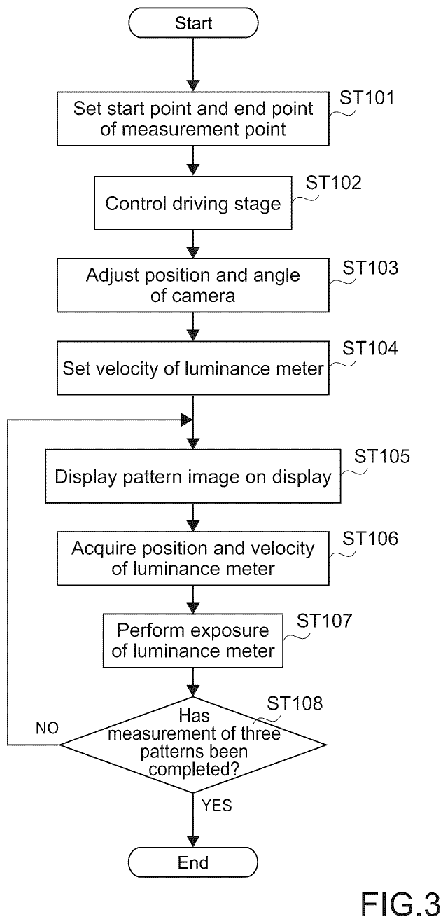

FIG. 3 is a flowchart showing measurement of the luminance data.

As shown in FIG. 3, the measurement point setting unit 22 sets the start point and the end point of the measurement point (Step 101). The movement control unit 23 controls the movement apparatus 3 (Step 102). For example, the driving stage 5 is controlled so that the luminance meter 1 moves to the set start point of the measurement point.

The position and angle of the camera 11 that tracks the object associated with the luminance meter 1 are adjusted (Step 103). For example, the determination unit that determines whether or not the camera 11 is correctly tracking the object 2 may perform the adjustment or the user may be provided with a message, a graphical user interface (GUI), or the like for prompting the user to adjust the position and angle of the camera 11.

The movement control unit 23 sets the velocity of the luminance meter 1 (Step 104). In the present embodiment, crosstalk at each predetermined velocity of the luminance meter 1 is evaluated. For example, the movement control unit 23 is set so that the luminance meter 1 moves from the start point to the end point at 5 cm/s. Moreover, for example, in a case where measurement has been completed at a set velocity, measurement may be performed at a different velocity at the same measurement point.

That is, the measurement may be performed at a plurality of different velocities of the luminance meter 1 with respect to a single measurement point and crosstalk may be evaluated on the basis of luminance data at each of these velocities. As a matter of course, also with respect to a newly set measurement point, evaluation may be performed in a similar way.

The image control unit 25 displays the pattern images on the auto-stereoscopic display 10 (Step 105). From Step 105, the movement of the luminance meter 1 is started and the measurement of the luminance data is performed. In the present embodiment, by the movement control unit 23 controlling the driving stage 5, the luminance meter 1 moves between the start point and the end point of the measurement point set by the measurement point setting unit 22.

The information acquisition unit 21 acquires the movement information of the luminance meter 1 (Step 106). In the present embodiment, the information acquisition unit 21 acquires the position and velocity of the luminance meter 1.

The exposure control unit 24 performs exposure of the luminance meter 1 (Step 107). In the present embodiment, the exposure control unit 24 outputs the exposure ON trigger to the luminance meter 1 when the luminance meter 1 reaches the velocity set between the start point and the end point.

Whether or not measurement of all pattern images of the white images, the black images, and the particular images including a predetermined pattern displayed on the auto-stereoscopic display 10 has been completed is determined (Step 108). In the present embodiment, the measurement completion refers to that fact that luminance data when a sufficient amount of exposure has been successfully secured has been acquired. That is, when the white images are displayed on the auto-stereoscopic display 10, exposure of the luminance meter 1 is performed multiple times, a sufficient amount of exposure is secured, and luminance data is acquired, and then the measurement of a first pattern is completed.

In a case where the measurement of all pattern images has not been completed (NO in Step 108), the black images are displayed on the auto-stereoscopic display 10. From Step 106 and 107, when the black images are displayed, exposure of the luminance meter 1 is performed multiple times and luminance data is acquired, and then measurement of patterns of both eyes is completed. Also, when the particular images including a predetermined pattern are displayed, exposure of the luminance meter 1 is performed multiple times and luminance data is acquired, and then measurement of a third pattern is completed.

In a case where the measurement of all pattern images has been completed (YES in Step 108), the evaluation unit 26 calculates a value of crosstalk on the basis of the acquired luminance data.

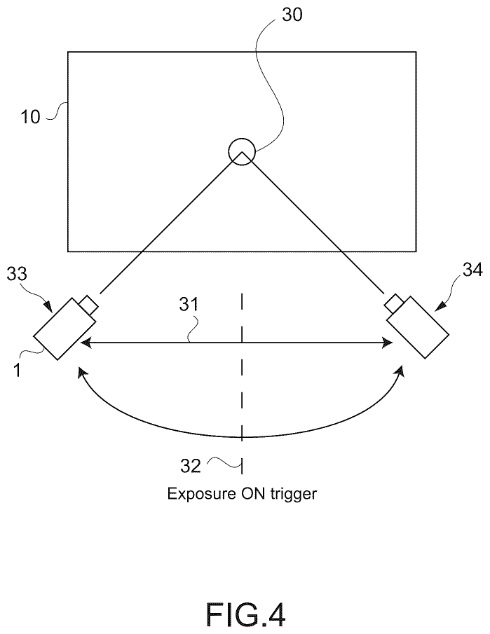

FIG. 4 is a view schematically showing another measurement example of the luminance meter 1.

In FIG. 4, the measurement point setting unit 22 sets a single point as a measurement point 30. In this case, the movement control unit 23 controls the movement apparatus (not shown) so that the luminance meter 1 moves in a circular arc around the measurement point 30.

Moreover, in a case where the movement apparatus is driven only in a predetermined direction (direction of the line 31), the movement control unit 23 may control the angle of the luminance meter 1 so that the luminance meter 1 constantly faces the measurement point 30. It should be noted that the angle of the luminance meter 1 does not need to be controlled depending on a distance (range) by which the luminance meter 1 moves.

The exposure control unit 24 outputs the exposure ON trigger when the luminance meter 1 reaches a predetermined position 32 and a predetermined velocity. It should be noted that the exposure control unit 24 may output the exposure ON trigger two times by reciprocation of an initial position 33 and a stop position 34. Moreover, luminance values acquired in respective measurements may be averaged as the acquired luminance data.

Accordingly, the accuracy of the luminance measurement can increase through simple repetition and averaging, and the same point can be measured.

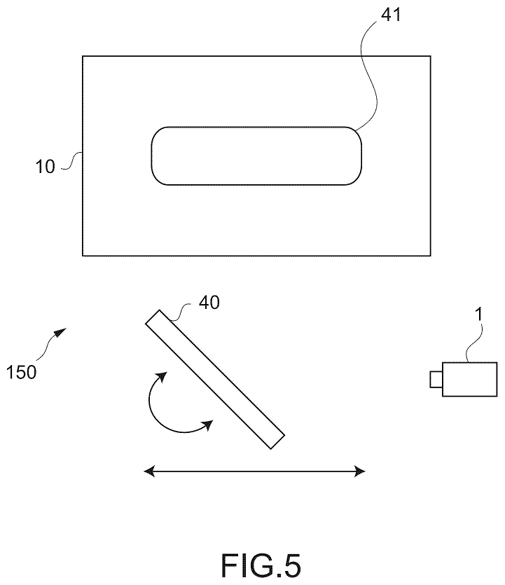

FIG. 5 is a view schematically showing another measurement example of the luminance meter 1.

As shown in FIG. 5, a measurement system 110 includes the auto-stereoscopic display 10, the luminance meter 1, a mirror 40, a mirror-moving apparatus (not shown) that moves the mirror 40, and the information processing apparatus 20 (not shown).

In the measurement system 110 shown in FIG. 5, the right-eye image or the left-eye image emitted from the auto-stereoscopic display 10 is reflected by the mirror 40 toward the fixed luminance meter 1. Moreover, the mirror 40 is capable to rotating and moving in any direction through the mirror-moving apparatus. It should be noted that the mirror-moving apparatus may have a configuration to be capable of either rotating or moving the mirror 40. In this case, the shape (measurement area) of a measurement point 41 is laterally long.

The measurement point setting unit 22 sets the measurement point 41. The movement control unit 23 controls the mirror-moving apparatus on the basis of the set measurement point 41. For example, the movement control unit 23 controls the mirror-moving apparatus so that the mirror 40 reaches the predetermined position and the predetermined velocity.

Moreover, the exposure control unit 24 outputs the exposure ON trigger on the basis of the position, velocity, or movement time of the mirror 40.

Accordingly, the drive portion can be simplified and the size and costs of the measurement system can be reduced.

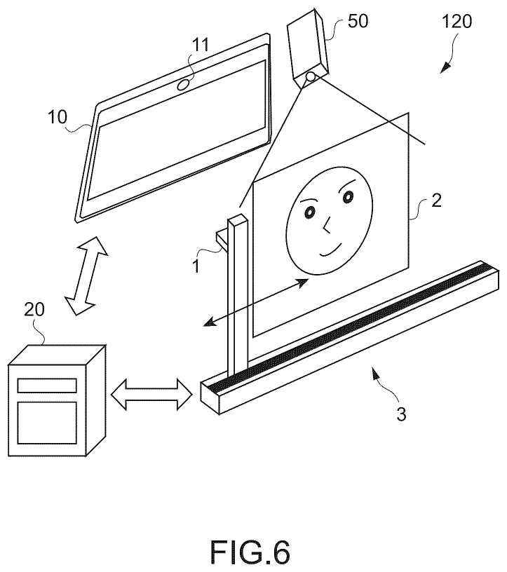

FIG. 6 is a schematic view showing another example of the measurement system.

As shown in FIG. 6, a measurement system 120 includes the luminance meter 1, the object 2, the movement apparatus 3, the auto-stereoscopic display 10, the information processing apparatus 20, and a light source 50.

In FIG. 6, the light source 50 is used for tracking the camera 11 mounted on the auto-stereoscopic display 10. In the present embodiment, the light source 50 emits light out of a visible range to the object 2 that is a tracking target. For example, infrared (IR) light is used as the light out of the visible range.

Accordingly, lowering of the measurement accuracy due to stray light can be prevented and the measurement accuracy can increase.

Hereinabove, the measurement system 100 according to the present embodiment includes the luminance meter 1, the object 2, the auto-stereoscopic display 10 that includes the camera 11 that tracks the object 2 and emits the right-eye image or the left-eye image to the luminance meter 1, the movement apparatus 3, and the information processing apparatus 20. The information processing apparatus 20 controls the movement apparatus 3 in accordance with the measurement point 12 based on the auto-stereoscopic display 10, controls the exposure timing of the luminance meter 1 on the basis of the movement information regarding the movement time of the luminance meter 1, and acquires the sum of the respective amounts of exposure as the luminance data in a case where the sum of the respective amounts of exposure acquired at at least one exposure timing has satisfied a predetermined condition. Accordingly, a high-quality viewing experience can be realized.

Conventionally, in the display apparatus that enables a stereoscopic image such as an auto-stereoscopic display to be viewed, crosstalk occurs and affects the video quality and flat fusion for a 3D video. It is difficult to accurately measure such crosstalk with the luminance meter. In particular, in a case where the luminance meter moves, it is difficult to secure the accuracy at low luminance due to an insufficient exposure duration, and thus the measurement accuracy of the crosstalk.

In the present technology, measurement is performed multiple times on the basis of the position and velocity of the moving luminance meter. Accordingly, complementing the insufficiency of the exposure duration, the amount of exposure can be sufficiently secured, sufficient accuracy can be obtained for the luminance measurement, and a high-accuracy crosstalk measurement can be performed. Moreover, measurement can be performed only by aimed setting for performing exposure when the luminance meter reaches the predetermined position and the predetermined velocity, and the measurement accuracy can increase. Moreover, since the luminance meter moves in parallel with the measurement point, the configuration and installation of the measurement apparatus can be simplified.

### Other Embodiments

The present technology is not limited to the above-mentioned embodiment, and various other embodiments can be realized.

In the above-mentioned embodiment, the exposure control unit 24 outputs the exposure ON trigger only when the luminance meter 1 is at the predetermined position and the predetermined velocity. The present technology is not limited thereto, and the timing to perform exposure may be arbitrarily set. For example, the exposure control unit 24 may stop the exposure of the luminance meter other than a desired time zone. Accordingly, it is possible to reduce the influence of dark current of the sensor and increase the accuracy.

In the above-mentioned embodiment, the luminance meter 1 moves to the measurement point multiple times and the luminance measurement is performed. The present technology is not limited thereto, and a luminance distribution of the measurement point may be measured in advance and the luminance data may be complemented.

In the above-mentioned embodiment, the auto-stereoscopic display 10 displays a stereoscopic image of the right-eye image and the left-eye image. The present technology is not limited thereto, and an eyeglasses-type display apparatus capable of displaying a stereoscopic image may be used. For example, the luminance meter may detect the luminance by measuring a stereoscopic vision display that alternately outputs the right-eye image and the left-eye image at predetermined time intervals through the eyeglasses-type display apparatus capable of alternately shielding a lens on the side of the right eye and a lens on the side of the left eye at predetermined time intervals.

In the above-mentioned embodiment, the position and velocity of the luminance meter 1 are acquired in Step 106. The present technology is not limited thereto, and only the position of the luminance meter 1 may be acquired and the exposure ON trigger may be output. For example, in a case where there is a sufficient distance between the position of the luminance meter 1 before it moves and a position where it reaches the velocity of the luminance meter 1 set in Step 104 with respect to the predetermined position, the exposure ON trigger may be output when the luminance meter 1 reaches the predetermined position.

In the above-mentioned embodiment, in Step 108, the three patterns of images, i.e., the black images, the white images, and the particular images including a predetermined pattern, are emitted from the auto-stereoscopic display 10. The present technology is not limited thereto, and any number of pattern images may be emitted. For example, in a case where the luminance data of the black images and the white images is measured in advance, the luminance data may be used. That is, in Step 108, it may be determined that measurement has been completed only by measurement of the particular images including a predetermined pattern.

In the above-mentioned embodiment, the luminance measurement at the single measurement point is performed. The present technology is not limited thereto, and the luminance measurement may be performed at a plurality of measurement points. For example, the luminance meter may pass through the plurality of measurement points and measure the luminance at each measurement point. In this case, the evaluation unit 26 may evaluate crosstalk at each measurement point on the basis of luminance data at each measurement point.

FIG. 7 is a block diagram showing a hardware configuration example of the information processing apparatus 20.

The information processing apparatus 20 includes a CPU 201, a ROM 202, a RAM 203, an input/output interface 205, and a bus 204 that connects them to one another. A display unit 206, an input unit 207, a storage unit 208, a communication unit 209, a drive unit 210, and the like are connected to the input/output interface 205.

The display unit 206 is, for example, a display device using liquid crystals, EL, or the like. The input unit 207 is, for example, a keyboard, a pointing device, a touch panel, or another operation device. In a case where the input unit 207 includes a touch panel, the touch panel can be integral with the display unit 206.

The storage unit 208 is a nonvolatile storage device. The storage unit 208 is, for example, an HDD, a flash memory, or another solid-state memory. The drive unit 210 is, for example, a device capable of driving a removable recording medium 211 such as an optical recording medium or a magnetic record tape.

The communication unit 209 is a modem, a router, or another communication device for communicating with other devices, which is connectable to a LAN, a WAN, or the like. The communication unit 209 may perform wired communication or may perform wireless communication. The communication unit 209 is often used separately from the information processing apparatus 20.

Cooperation of software stored in the storage unit 208, the ROM 202, or the like with hardware resources of the information processing apparatus 20 achieves information processing of the information processing apparatus 20 having the hardware configurations as described above. Specifically, loading a program that configures the software, which has been stored in the ROM 202 or the like, to the RAM 203 and executing it achieves the information processing according to the present technology.

The information processing apparatus 20 installs the program via the recording medium 211, for example. Alternatively, the information processing apparatus 20 may install the program via a global network or the like. Otherwise, any computer-readable non-transitory storage medium may be used.

Cooperation of a computer mounted on a communication terminal with another computer capable of communicating with it via a network or the like may execute the measurement method and the program according to the present technology and configure the evaluation unit according to the present technology.

That is, the measurement system, the information processing apparatus, the measurement method, and the program according to the present technology may be performed not only in a computer system constituted by a single computer but also in a computer system in which a plurality of computers cooperatively operate. It should be noted that in the present disclosure, the system means a set of a plurality of components (e.g., apparatuses, modules (parts)) and it does not matter whether or not all the components are housed in the same casing. Therefore, both of a plurality of apparatuses housed in separate casings and connected to one another via a network and a single apparatus having a plurality of modules housed in a single casing are the system.

Executing the measurement system, the information processing apparatus, the measurement method, and the program according to the present technology by the computer system includes, for example, both of a case where a single computer executes, for example, setting of the measurement point, control of the exposure timing, and the evaluation of crosstalk, and the like, and a case where different computers execute the respective processes. Moreover, executing the respective processes by a predetermined computer includes causing another computer to execute some or all of those processes and acquiring the results.

That is, the measurement system, the information processing apparatus, the measurement method, and the program according to the present technology can also be applied to a cloud computing configuration in which a plurality of apparatuses shares and cooperatively processes a single function via a network.

The respective configurations such as the measurement point setting unit, the exposure control unit, and the evaluation unit, the control flow of the communication system, and the like, which have been described with reference to the respective drawings, are merely embodiments, and can be arbitrarily modified without departing from the gist of the present technology. That is, any other configurations, algorithms, and the like for carrying out the present technology may be employed.

It should be noted that the effects described in the present disclosure are merely exemplary and not limitative, and further other effects may be provided. The description of the plurality of effects above does not necessarily mean that those effects are provided at the same time. It means that at least any one of the above-mentioned effects is obtained depending on a condition and the like, and effects not described in the present disclosure can be provided as a matter of course.

At least two features of the features of the above-mentioned embodiments may be combined. That is, the various features described in the respective embodiments may be arbitrarily combined across the respective embodiments.

It should be noted that the present technology can also take the following configurations.

(1) A measurement system, including:
a luminance meter;
an object associated with the luminance meter;
an image display apparatus that includes a sensor unit that tracks the object and emits a right-eye image or a left-eye image to the luminance meter;
a movement apparatus that moves the luminance meter; and
an information processing apparatus including
   a movement control unit that controls the movement apparatus in accordance with a measurement point based on the image display apparatus,
   a first acquisition unit that acquires movement information regarding a movement time of a luminance meter, the movement information including at least position information of the luminance meter,
   an exposure control unit that controls an exposure timing of the luminance meter on the basis of the movement information, and
   a second acquisition unit that acquires, in a case where a sum of the respective amounts of exposure acquired at the at least one exposure timing has satisfied a predetermined condition, the sum of the respective amounts of exposure as luminance data.

(2) The measurement system according to (1), in which
the information processing apparatus includes an evaluation unit that evaluates crosstalk of the image display apparatus on the basis of the luminance data.

(3) The measurement system according to (1), in which
the movement information includes a velocity of the luminance meter, and
the exposure control unit starts exposure of the luminance meter in a case where the luminance meter has reached a predetermined position and a predetermined velocity.

(4) The measurement system according to (1), in which
the movement information includes a movement time of the luminance meter, and
the exposure control unit stops exposure of the luminance meter in a case where the movement time is other than a predetermined time zone.

(5) The measurement system according to (1), in which
the information processing apparatus includes a setting unit that sets the measurement point, and
the setting unit sets a predetermined position at which the crosstalk of the image display apparatus is assumed to occur or a region including the predetermined position as the measurement point.

(6) The measurement system according to (5), in which
the movement control unit controls the movement apparatus so that the luminance meter moves in accordance with a shape of the region.

(7) The measurement system according to (6), in which
the setting unit sets a region having a shape extending in a predetermined direction as the measurement point, and
the movement control unit controls the movement apparatus so that the luminance meter moves in the predetermined direction.

(8) The measurement system according to (5), in which
the movement control unit controls the movement apparatus so that the luminance meter moves in a circular arc on the basis of the predetermined position.

(9) The measurement system according to (2), in which
the evaluation unit evaluates the crosstalk on the basis of a luminance distribution of the measurement point measured in advance and the luminance data.

(10) The measurement system according to (1), further including
a mirror that reflects the right-eye image or the left-eye image toward the luminance meter.

(11) The measurement system according to (10), further including
a mirror-moving apparatus that rotates and moves the mirror, in which
the movement control unit controls the mirror-moving apparatus to fix the luminance meter and cause the right-eye image or the left-eye image to enter the luminance meter.

(12) The measurement system according to (1), further including
a light source that emits light out of a visible range to the object, and
the light out of the visible range is infrared light.

(13) The measurement system according to (2), in which
the evaluation unit calculates a value of crosstalk on the basis of the luminance data in each region of the right-eye image or the left-eye image.

(14) The measurement system according to (1), in which
the information processing apparatus includes a display control unit that controls the right-eye image and the left-eye image emitted from the image display apparatus, and
the display control unit controls white images, black images, or particular images including a predetermined pattern to be emitted as the right-eye image and the left-eye image.

(15) An information processing apparatus, including:
a first acquisition unit that acquires movement information regarding a movement time of a luminance meter, the movement information including at least position information of the luminance meter;
an exposure control unit that controls an exposure timing of the luminance meter on the basis of the movement information; and
a second acquisition unit that acquires, in a case where a sum of the respective amounts of exposure acquired at the at least one exposure timing has satisfied a predetermined condition, the sum of the respective amounts of exposure as luminance data.

(16) The measurement system according to (15), further including
an evaluation unit that evaluates crosstalk of the image display apparatus on the basis of the luminance data.

(17) The information processing apparatus according to (15), further including
a movement control unit that controls a movement apparatus in accordance with a measurement point based on the image display apparatus, in which
the image display apparatus includes a sensor unit that tracks an object associated with the luminance meter.

(18) A measurement method executed by a computer system, including:
controlling the movement apparatus in accordance with a measurement point based on an image display apparatus that includes a sensor unit that tracks an object associated with a luminance meter and emits a right-eye image or a left-eye image to the luminance meter;
acquiring movement information regarding a movement time of a luminance meter, the movement information including at least position information of the luminance meter;
controlling an exposure timing of the luminance meter on the basis of the movement information; and
acquiring, in a case where a sum of the respective amounts of exposure acquired at the at least one exposure timing has satisfied a predetermined condition, the sum of the respective amounts of exposure as luminance data.

(19) A program that causes a computer system to execute
a step of controlling the movement apparatus in accordance with a measurement point based on an image display apparatus that includes a sensor unit that tracks an object associated with a luminance meter and emits a right-eye image or a left-eye image to the luminance meter;
a step of acquiring movement information regarding a movement time of a luminance meter, the movement information including at least position information of the luminance meter;
a step of controlling an exposure timing of the luminance meter on the basis of the movement information; and
a step of acquiring, in a case where a sum of the respective amounts of exposure acquired at the at least one exposure timing has satisfied a predetermined condition, the sum of the respective amounts of exposure as luminance data.

### REFERENCE SIGNS LIST

1 luminance meter
2 object
3 movement apparatus
10 auto-stereoscopic display
11 camera
20 information processing apparatus
21 information acquisition unit
22 measurement point setting unit
23 movement control unit
24 exposure control unit
25 image control unit
26 evaluation unit
40 mirror
50 light source
100 measurement system

1. A measurement system, comprising:
a luminance meter;
an object associated with the luminance meter;
an image display apparatus that includes a sensor unit that tracks the object and emits a right-eye image or a left-eye image to the luminance meter;
a movement apparatus that moves the luminance meter; and
an information processing apparatus including
a movement control unit that controls the movement apparatus in accordance with a measurement point based on the image display apparatus,
a first acquisition unit that acquires movement information regarding a movement time of a luminance meter, the movement information including at least position information of the luminance meter,
an exposure control unit that controls an exposure timing of the luminance meter on a basis of the movement information, and
a second acquisition unit that acquires, in a case where a sum of the respective amounts of exposure acquired at the at least one exposure timing has satisfied a predetermined condition, the sum of the respective amounts of exposure as luminance data.

2. The measurement system according to claim 1, wherein
the information processing apparatus includes an evaluation unit that evaluates crosstalk of the image display apparatus on a basis of the luminance data.

3. The measurement system according to claim 1, wherein
the movement information includes a velocity of the luminance meter, and
the exposure control unit starts exposure of the luminance meter in a case where the luminance meter has reached a predetermined position and a predetermined velocity.

4. The measurement system according to claim 1, wherein
the movement information includes a movement time of the luminance meter, and
the exposure control unit stops exposure of the luminance meter in a case where the movement time is other than a predetermined time zone.

5. The measurement system according to claim 2, wherein
the information processing apparatus includes a setting unit that sets the measurement point, and
the setting unit sets a predetermined position at which the crosstalk of the image display apparatus is assumed to occur or a region including the predetermined position as the measurement point.

6. The measurement system according to claim 5, wherein
the movement control unit controls the movement apparatus so that the luminance meter moves in accordance with a shape of the region.

7. The measurement system according to claim 6, wherein
the setting unit sets a region having a shape extending in a predetermined direction as the measurement point, and
the movement control unit controls the movement apparatus so that the luminance meter moves in the predetermined direction.

8. The measurement system according to claim 5, wherein
the movement control unit controls the movement apparatus so that the luminance meter moves in a circular arc on a basis of the predetermined position.

9. The measurement system according to claim 2, wherein
the evaluation unit evaluates the crosstalk on a basis of a luminance distribution of the measurement point measured in advance and the luminance data.

10. The measurement system according to claim 1, further comprising
a mirror that reflects the right-eye image or the left-eye image toward the luminance meter.

11. The measurement system according to claim 10, further comprising
a mirror-moving apparatus that rotates and moves the mirror, wherein
the movement control unit controls the mirror-moving apparatus to fix the luminance meter and cause the right-eye image or the left-eye image to enter the luminance meter.

12. The measurement system according to claim 1, further comprising
a light source that emits light out of a visible range to the object, and
the light out of the visible range is infrared light.

13. The measurement system according to claim 2, wherein
the evaluation unit calculates a value of crosstalk on a basis of the luminance data in each region of the right-eye image or the left-eye image.

14. The measurement system according to claim 1, wherein
the information processing apparatus includes a display control unit that controls the right-eye image and the left-eye image emitted from the image display apparatus, and
the display control unit controls white images, black images, or particular images including a predetermined pattern to be emitted as the right-eye image and the left-eye image.

15. An information processing apparatus, comprising:
a first acquisition unit that acquires movement information regarding a movement time of a luminance meter, the movement information including at least position information of the luminance meter;
an exposure control unit that controls an exposure timing of the luminance meter on a basis of the movement information; and
a second acquisition unit that acquires, in a case where a sum of the respective amounts of exposure acquired at the at least one exposure timing has satisfied a predetermined condition, the sum of the respective amounts of exposure as luminance data.

16. The measurement system according to claim 15, further comprising
an evaluation unit that evaluates crosstalk of the image display apparatus on a basis of the luminance data.

17. The information processing apparatus according to claim 15, further comprising
a movement control unit that controls a movement apparatus in accordance with a measurement point based on the image display apparatus, wherein
the image display apparatus includes a sensor unit that tracks an object associated with the luminance meter.

18. A measurement method executed by a computer system, comprising:
controlling the movement apparatus in accordance with a measurement point based on an image display apparatus that includes a sensor unit that tracks an object associated with a luminance meter and emits a right-eye image or a left-eye image to the luminance meter;
acquiring movement information regarding a movement time of a luminance meter, the movement information including at least position information of the luminance meter;
controlling an exposure timing of the luminance meter on a basis of the movement information; and
acquiring, in a case where a sum of the respective amounts of exposure acquired at the at least one exposure timing has satisfied a predetermined condition, the sum of the respective amounts of exposure as luminance data.

19. A program that causes a computer system to execute
a step of controlling the movement apparatus in accordance with a measurement point based on an image display apparatus that includes a sensor unit that tracks an object associated with a luminance meter and emits a right-eye image or a left-eye image to the luminance meter;
a step of acquiring movement information regarding a movement time of a luminance meter, the movement information including at least position information of the luminance meter;
a step of controlling an exposure timing of the luminance meter on a basis of the movement information; and
a step of acquiring, in a case where a sum of the respective amounts of exposure acquired at the at least one exposure timing has satisfied a predetermined condition, the sum of the respective amounts of exposure as luminance data.
